(19) United States
(12) Patent Application Publication
(10) Pub. No.: US 2008/0059416 A1
(43) Pub. Date: Mar. 6, 2008

(54) SOFTWARE SYSTEM FOR RULES-BASED SEARCHING OF DATA

(76) Inventors: DAVID IAN FORBES, Falls Church, VA (US); Sharon Flank, Washington, DC (US); David Austin, Falls Church, VA (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/854,802

(22) Filed: Sep. 13, 2007

Related U.S. Application Data
(63) Continuation-in-part of application No. 11/225,138, filed on Sep. 13, 2005.
(60) Provisional application No. 60/609,845, filed on Sep. 15, 2004.

(51) Int. Cl. G06F 17/30

(52) U.S. Cl. 707/2; 707/E17.017

(57) ABSTRACT

In one embodiment, data associated with a process rules query is received. The data includes values associated with a predetermined constraint. Results for the process query are obtained from at least one data store. The obtained results for the process query are output in a first form and a second form. In another embodiment, a searchable process knowledgebase is created based on a business process (e.g., a structure consisting of activities and sub-activities). The business process is integrated into a process-based algorithm. Obtained process query results are added to the process knowledgebase. Executed process queries are analyzed so that the process-based query algorithm learns and improves precision of obtained query results.

### CROSS-REFERENCE TO RELATED APPLICATIONS

This application is a continuation-in-part of U.S. patent application Ser. No. 11/225,138, entitled “Software System for managing information in context” filed on Sep. 13, 2005, which claims priority to U.S. Provisional Application No. 60/609,845 entitled “Software System for managing information in context” filed Sep. 15, 2004.

### BACKGROUND

This invention relates generally to software-based search technology, and particularly to rules-based (rules being any standardized set of principles or methods for organizing and structuring information (e.g. The AP Style Manual; IDEF, a business process language; the Marquess of Queensberry rules for boxing) searching via a constrained or guided query structure.

Current technologies for searching data stores such as the Internet do little to aid the user in building a precise and optimal query. Such products provide no help in selection of query terms necessary for effectively returning the most accurate and useful possible results. The algorithms of such search products must also search the relevant data store using a query lacking any indication of user intent or context. This forces the algorithm to cast the widest possible net, resulting in unnecessary processor-intensive searching, contextual confusion and a returned result set cluttered with irrelevant search results interspersed among the relevant results.

Using these search systems to inquire how to perform a certain task often returns scattered results of limited utility, forcing the user to sift through a significant magnitude of irrelevant results in search of an answer to the original question.

Thus a need exists for a software-based search method that aids the user in crafting an optimal query, searches for how to accomplish a certain task and returns an accurate, relevant and useful result set.

### SUMMARY OF THE INVENTION

In one embodiment, data associated with a process rules query is received. The data includes values associated with a predetermined constraint. Results for the process query are obtained from at least one data store. The obtained results for the process query are output in a first form and a second form.

In another embodiment, a searchable process knowledgebase is created based on a business process (e.g., a process consisting of activities and sub-activities). The business process is integrated into a process-based algorithm. Obtained process query results are added to the process knowledgebase. Executed process queries are analyzed so that the process-based query algorithm learns and improves precision of obtained query results.

### BRIEF DESCRIPTION OF THE DRAWINGS

FIG. 1 is a functional block diagram including a system, according to an embodiment of the invention.

FIG. 2 is a functional flow diagram, according to an embodiment of the invention.

FIG. 3 is a flow chart illustrating a method, according to an embodiment of the invention.

FIG. 4 is a flow chart illustrating a method, according to an embodiment of the invention.

FIG. 5 illustrates an example of a graphical user interface according to an embodiment of the invention.

FIG. 6 illustrates an example of a graphical user interface including a constrained field according to an embodiment of the invention.

FIG. 7 illustrates an example of a graphical user interface including a system-generated list of relevant query terms related to the user's initial input term according to an embodiment of the invention.

FIG. 8 illustrates an example of a graphical user interface including a returned result set according to an embodiment of the invention.

FIG. 9 illustrates an example of a graphical user interface including a returned result set according to an embodiment of the invention.

FIG. 10 illustrates an example of a graphical user interface including a returned result according to an embodiment of the invention.

### DETAILED DESCRIPTION

In one embodiment, the user is presented with a query entry screen within the context of a web browser. The user enters query terms into a text field box and submits the query for processing. Results are displayed within the web browser.

In some embodiments, upon entry of a query term, the user is provided with a list of suggested, related query terms for insertion into the query. In some embodiments, users are presented with advertisements related to the submitted query terms. In some embodiments, users can select results consisting of “expert advice”.

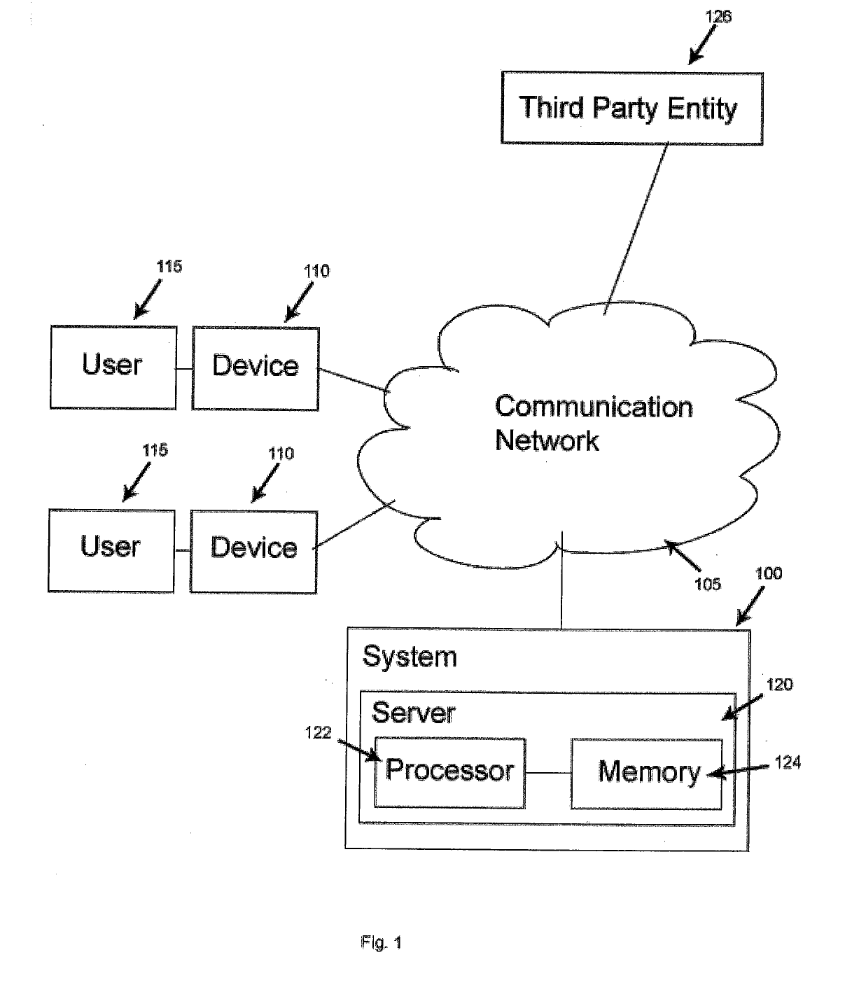

FIG. 1 is a functional block diagram including a system, according to an embodiment of the invention. The system includes an application server configured to receive from a user a query about a process and to output results/information to the user.

The systems and methods described herein can be embodied in one or more hardware and/or software programs. The methods of the invention are described herein as being embodied in computer programs (software and/or hardware) having code to perform a variety of different functions. It should be understood, however, that the methods are not limited to an electronic medium and various functions can be alternatively practiced in a manual setting. All of the various methods described herein can upload and deliver data associated with a process in a variety of different formats. For example, data associated with the process can be in textual format, in tabular format, graphical format, diagrammatical format, or chart format. The data associated with the process can be transmitted via a network connection and/or via email using the Internet.

The application server 120 according to an embodiment of the invention can be used to process data in accordance with the invention. Application server 120 includes a processor 122. The application server 120 can be in communication with one or more entities or devices (e.g., a device, a third party entity, etc.) via a broadband connection, or other high-speed network. The application server 120 can be in communication with one or more devices (e.g., a cellular phone, a computer, etc.) via a wireless or wired network. The processor 122 can be, for example, a commercially available personal computer, or a less complex computing or processing device that is dedicated to performing one or more specific tasks. For example, the processor 122 can be a terminal dedicated to providing an interactive graphical user interface (GUI). The processor 122, according to one or more embodiments of the invention, can be a commercially available microprocessor. Alternatively, the processor 122 can be an application-specific integrated circuit (ASIC) or a combination of ASICs, which are designed to achieve one or more specific functions, or enable one or more specific devices or applications. In yet another embodiment, the processor 122 can be an analog or digital circuit, or a combination of multiple circuits.

The processor 122 can include a memory 124. The memory 124 can include one or more types of memory. For example, the memory 124 can include a read only memory (ROM) component and a random access memory (RAM) component. The memory 124 can also include other types of memory that are suitable for storing data in a form retrievable by the processor 122. For example, electronically programmable read only memory (EPROM), erasable electronically programmable read only memory (EEPROM), flash memory, as well as other suitable forms of memory can be included within the memory 124. The processor 122 can also include a variety of other components, such as for example, co-processors, graphic processors, etc., depending upon the desired functionality of the code.

The processor 122 is in communication with the memory 124, and can store data in the memory 124 or retrieve data previously stored in the memory 124. In other words, the memory 124 can be a processor-readable medium storing code representing instructions to cause the processor 122 to perform a process. The code can be any interpretable or executable code mechanism, such as, for example, interpretable programs, dynamic link libraries (DLLs), Java classes and applets, complete executable programs, and the like.

The components of the processor 122 can communicate with devices external to the processor 122 by way of an input/output (I/O) component (not shown). According to one or more embodiments of the invention, the I/O component can include a variety of suitable communication interfaces. For example, the I/O component can include, for example, wired connections, such as standard serial ports, parallel ports, universal serial bus (USB) ports, S-video ports, local area network (LAN) ports, small computer system interface (SCSI) ports, and so forth. Additionally, the I/O component can include, for example, wireless connections, such as infrared ports, optical ports, Bluetooth® wireless ports, wireless LAN ports, or the like. The network to which the processor 122 is connected can be physically implemented on a wireless or wired network, on leased or dedicated lines, including a virtual private network (VPN).

The application server 120 can communicate with devices 110 of users 115 and third party entities 126 via a communication network 105. The communication network can be, for example, a cellular network, a wireless network, the Internet, or the like.

The device 110 can be used by a user 115 to interface with the system 100. Specifically, the user 115 can interface using the device 110 across the communication network 105 for various purposes (i.e., to send data to and receive data from the application server 120). Throughout this specification, several references to the term “user” is made for convenience. The term “user” can include, for example, a person, a device, a handset, a cell phone being used by a user, an entity, etc.

In one embodiment, the device 110 can be any known device capable of producing a signal associated with input from the user 115 and sending data associated with input from the user 115. The device 110 is capable of sending data over a wireless and/or wired network. The device 110 can be, for example, a processor system including one or more processors, a server as described above, an IP enabled appliance/device, a computer, a workstation, a thin-client, a personal digital assistant (PDA), a mobile communication device, a cellular phone, or any other processor. The data associated with input from the user 115 can be produced by any known textual input device, such as, for example, a telephone keypad, a keyboard, or the like. The device 110 can include a display configured to display GUIs and other windows to the user 115.

The application server 120 can include a platform or component located in the memory 124. The platform can be configured to interface with the device 110 to produce task-based query data as well as other data. In one embodiment, the platform is streamed from the application server 120 to the device 110 via the communication network 105. In other words, at least a portion of the platform is continuously sent by the application server 120 and received by the device 110. In some embodiments, the platform is downloaded locally at the device 110 from the application server 120 via the communication network 105. In some embodiments, at least a first portion of the platform is streamed from the application server 120 to the device 110 and at least a second portion of the platform is downloaded locally at the device 110.

The application server 120 can output an interactive GUI to the device 110 such that the device 110 can display the GUI to the user 115. The device can receive input from the user associated with instructions for the GUI. In some embodiments, the application server 120 includes a web platform comprising J2EE, XML/XSLT, JSP, and SQL technologies to deliver an Internet search site and defines business processes using Integrated Definition (IDEF) business process language (a FIPS standard).

The application server 120 can search a third party entity 126 for a process based on the task-based query of the user. The third party entity 126 can include a processor system, such as, for example, a server as described above, a computer, a thin-client, or the like. The data associated with the process can be stored in a memory component of the processor system of the third party entity 126.

The system 100 can include a knowledgebase (e.g., a database, a data warehouse) coupled to the application server 120. In some embodiments, the knowledgebase is stored within the memory 124. The knowledgebase (not shown) is a deep archive of experiential knowledge. The archive can include data associated with a task-based process and/or one or more locations of data associated with a task-based process. For example, the knowledgebase can include the actual steps of a process or the location of a website that includes the actual steps of the process. The knowledgebase is searchable via a process-based query algorithm. The knowledgebase can analyze executed process queries so that the process-based query algorithm learns and improves precision of obtained process query results.

The knowledgebase can be based on a business process. As stated above, in some embodiments, a business process includes a process consisting of activities and sub-activities. Each activity in a process can have sub-activities. For example, the business process can include process data types and process data roles. Process data roles determine the relation of a process data type to a specific activity or task. Process data roles can include inputs, controls, outputs and mechanisms. The process data roles can be subdivided into logical subtypes such as, for example, “mechanisms>people” or “mechanisms>tools.” Process data roles determine the relevance of process data types. Process data types can be, for example, various types of data, content, information, resources, software, systems, hardware and people that use or are utilized in performing the activity or task. Process data types can have interdependencies between activities (data type X is an output of activity A, and data type X also serves as an input to activity B). In an information taxonomy, process data types are also know as topics.

The application server 120 can send signals to and receive signals from the device 110 or another entity. Similarly, the device 110 can send signals to and receive signals from the application server 120 or another entity. In some embodiments, the signals can include control signals including instructions pertinent to a particular task-based query.

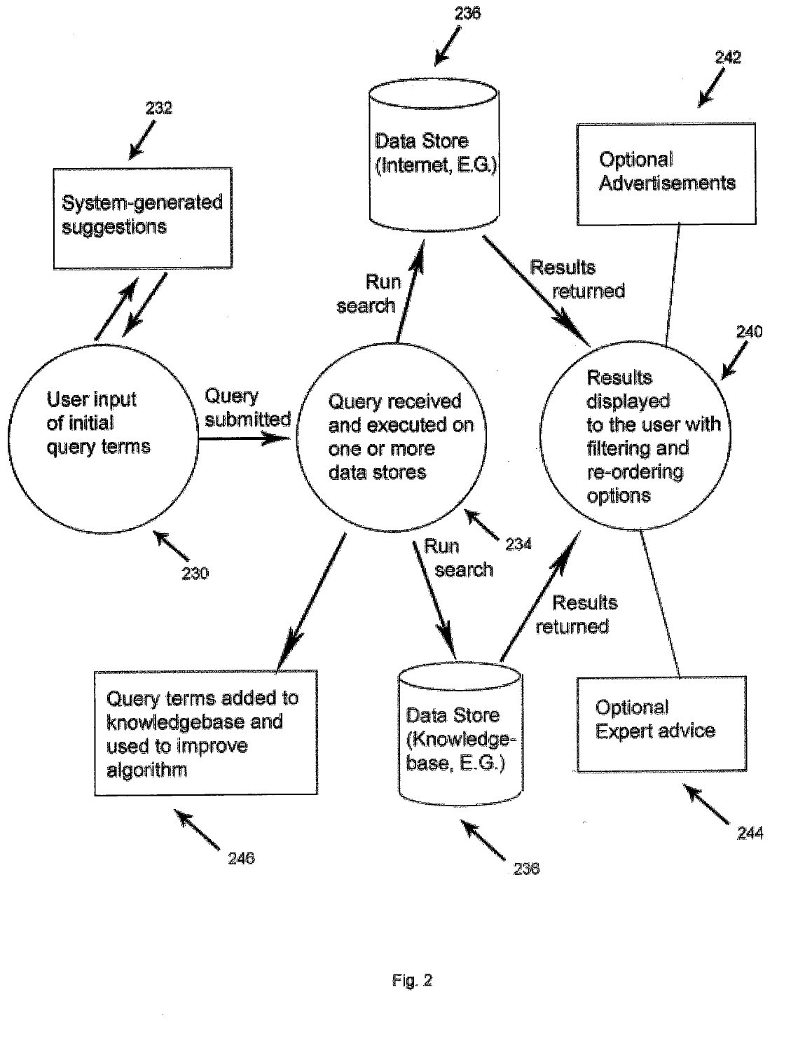

FIG. 2 is a functional flow diagram of a process-based search, according to an embodiment of the invention. The user inputs, at 230, initial process query terms into a GUI output by the application server. The process query term can be, for example, the collective set of keywords entered by the user into the search application. The GUI includes a constrained query entry structure that requires the user to enter terms into two or more text boxes that mimic grammatically-correct sentence structure. In one embodiment, a first text box requires a singular verb and a second text box requires a subject or noun of one or more words. Other elements of a sentence can also be suggested as modifiers (e.g., adjectives, etc.). In some embodiments, as the user enters/inputs characters into a text box, the application server automatically outputs, at 232, system-generated suggestions for semantically-related alternative or complementary query terms.

The multiple text boxes constrain the user from drafting poor or inadequate process queries. The user is only able to perform permitted functions so that brevity and clarity are enforced. For example, in the verb box, when the space bar is hit to enter a second word, the cursor moves to the next box (e.g., to enter a noun) so that the user is forced to reconsider the initial verb and determine whether it is adequate to adequately communicate intent or if another word should be used since there can be only one.

Upon submission of the query to the application server, the received query terms and associated concepts are automatically modified and optimized, at 234, before searching one or more data stores 236 and/or a search index. The data stores 236 can, include for example, the Internet, the knowledgebase, a database, a library, or the like. Specifically, natural language processing (NLP), Boolean and other logic types are used to modify the search criteria for more precision and relevancy. For example, semantic relationships of process data roles and process data types can be used to filter through the index. More specifically, the process search utilizes natural language, by incorporating synonyms and related terms, or a taxonomy, such as WordNet, to perform a fuzzy match (e.g., best available choice with related terms permitted) on the process terms, to search process and object information and resources for similar concepts.

The application server can also execute secondary result processing. In other words, upon retrieval of results by the application server and before display to the user, the NLP process data types can be factored back into and matched up with the original results to provide overall results. Accordingly, results that include the pre-determined process data types within their content rank higher than results that do no include, or only partially include, the pre-determined process data types. For example, if the process query is “build a deck” and process data types are determined to be “carpenter” and “deck screws” and “concrete,” the initial results that include those terms would rank higher than they perhaps had previously.

In one embodiment, the application server launches multiple subsidiary and simultaneous queries into a body of data and information as determined by process data roles and process data types in conjunction with NLP and semantic relationships. For example, using a lexical database and/or a statistical analysis of correlations, if the process query is “build a deck” then process data role is “mechanism>people,” and process data type is “expert” then NLP knows that “carpenter” is a type of expert who can build a deck.” Thus, many semantically related terms and concepts (as defined by process rules) are identified and used to filter through the index.

The process results are output, at 240, from the application server to the device and displayed to the user of the device via a GUI. Process query results can be, for example, the broad “how to” or step by step search results returned to satisfy the process query. When the process search results are displayed, information is categorized by the process data role or relevance the specific results play in the process term that has been queried. For example, if process query is “How do I replace a carburetor” then the data role called “tools” would know that a wrench is a kind of tool, or process data type.

The GUI output from the application server is configured to facilitate user-driven result refinement. Specifically, upon display of the final search results, the user can navigate and refine search results based on the activities and topics associated with the search query in a variety of media types, including for example, video, images, text, documentation, etc. The user can refine search terms, using grammatical rules, by deconstructing and reconstructing query terms, with NLP suggesting complementary terms, concepts and words. The user can also filter results by process data types or process data role. For example, the user can also actively filter the primary query for new and different results by process data type (show me more results with “concrete), or process data role (show me more results with “tools”). If the process search results include steps or sub-activities of the search term, these too can be used to refine the search by navigating sub-activities and subtasks associated with the initial process query. For example, if a step in buying a new car is “calculate monthly payments” that would be used to refine process search results from “buy new car.” Search results can also be filtered by object characteristics, such as, for example, processes that only include an employee object and a certain keyword type. Search results can be refined by their semantic relationships to other activities and objects (i.e., these are a kind of this, this is a kind of this, show me more like this). Searches can be constrained by range as well (e.g., only provide results when these search terms occur within 100 words/the same sentence/same paragraph).

In some embodiments, in addition to filtering by process data role, an algorithm is run that refines and reorganizes the process query results by using frequency of occurrence of process data types to gauge relevance. In some embodiments, the user can select an expert, at 244, to request specialists or practitioners with special knowledge about the queried process for expert advice or to hire. These different filtering and ordering features provide the user with varied options for answering the original query (be it via steps, expert guidance, a professional to hire, or equipment purchase).

In one embodiment, the advertisements 242 associated with the results can be displayed to the user. In other words, the advertisements displayed are based on the search query. The application server performs a precise match with user intent/purpose and advertiser offering, delivering targeted advertising using the process query, process query results, process data types and process data roles as filters and providing a precise one to one experience for both searcher and advertiser. The targeted advertising is displayed along with query results according to the process query itself, results, process data types and process data roles.

In some embodiments, the application server includes an automated improvement algorithm 246. Specifically, the process data types and queries are archived so that the accuracy and speed of future searches improves over time. The library can also be augmented with manually-input business process queries created via a separate software tool, such as an application running in a web browser. Said differently, the application server archives and indexes process queries and process data types so that the system learns and improves, delivering an increasingly rich user experience via more accurate process query results. A system taxonomy is built automatically through user queries, referencing the source lexical database and speeding future similar queries. The lexical database itself is editable, so terminology unique to the user population can be added and referenced.

In some embodiments, business process models can be created and incorporated into the application server to augment and enhance process queries. These business process models are primarily entirely through a web browser to support a knowledgebase that is integrated into the process search query.

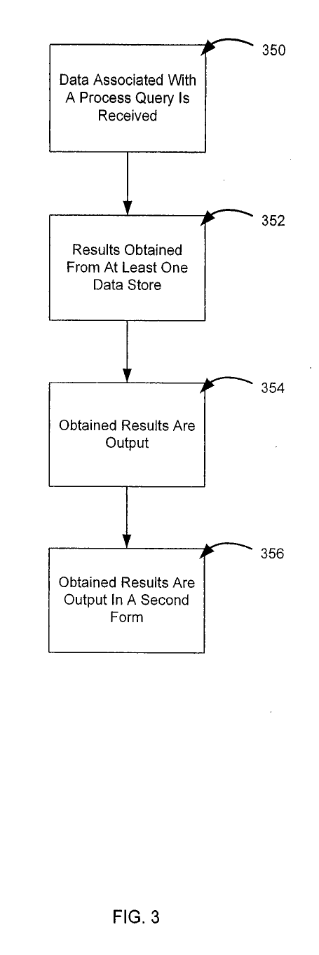

FIG. 3 is a flow chart illustrating a method, according to an embodiment of the invention. At 350, data associated with a process query is received. The data can be received via a web browser. The data includes values associated with a predetermined constraint. The predetermined constraint can include limiting the data associated with a process query to include a subject and a verb. At 352, results are obtained for the process query from at least one data store. The data store can be, for example, data stored on a computer network, a process knowledgebase, and the like. In one embodiment, the process query is refined based on alternative process query terms. In another embodiment, the process query is refined based on alternative terms selected from a predetermined data set. At 354, the obtained results for the process query are output in a first form. At 356, the obtained results for the process query are output in a second form. In some embodiments, the obtained results are categorized by data type.

In some embodiments, the obtained results are reordered by relevance based upon the quantity of occurrences of a particular process data type within the obtained results. In some embodiments, the obtained results are limited to results containing the advice of experts. In some embodiments, advertisements related to the process query are displayed.

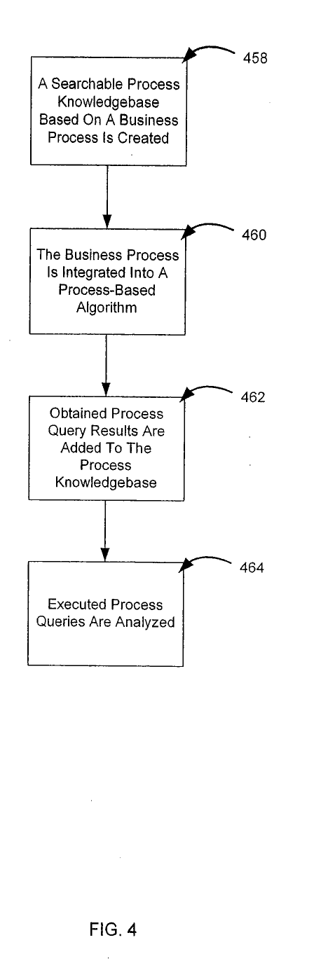

FIG. 4 is a flow chart illustrating a method, according to an embodiment of the invention. At 458, a searchable process knowledgebase is created based on a business process. The creation of the business process can take place in a web browser. The business process is modifiable by use of an editing tool. At 460, the business process is integrated into a process-based query algorithm. At 462, the obtained process query results are added to the process knowledgebase. At 464, executed process queries are analyzed so that the process-based query algorithm learns and improves precision of obtained process query results.

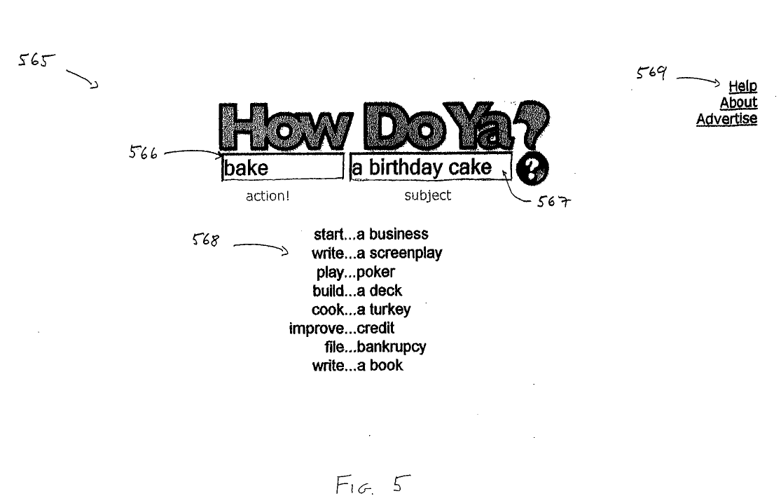

FIG. 5 illustrates an example of a graphical user interface including two fields according to an embodiment of the invention. A GUI 565 includes a first text box 566 and a second text box 567. The first text box 566 constrains the user to entering a term associated with an action (e.g., a verb) for the search. The second text box 567 constrains the user to entering one or more terms associated with a subject (e.g., a noun) for the search. The GUI 565 can display examples 568 of searches to aid the user in term choice for the action term and the one or more subject terms. The GUI 565 can also display a link 569 to gain more information about the process.

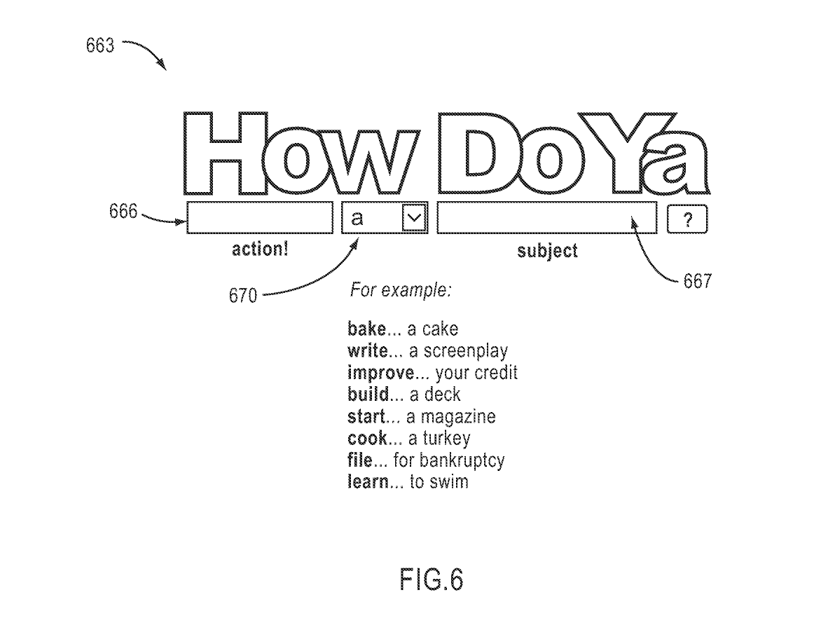

FIG. 6 illustrates an example of a GUI 663 that includes multiple constrained fields according to an alternative embodiment of the invention. The GUI 663 includes a first text box 666 and a second box 667 as described above. In this embodiment, the GUI 663 also includes a third text box 670. The third text box 670 includes a dropdown list of available options including articles (e.g., a, an) or modifiers. In some embodiments, the options can indicate quantity. In other embodiments, the user can manually enter a constrained value, modifier or term into the third text box 670 for the search.

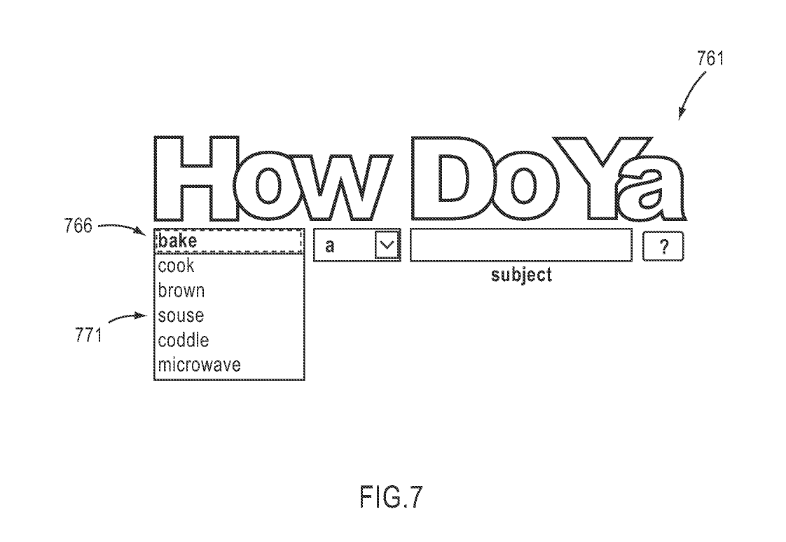

FIG. 7 illustrates an example of a GUI 761 including a system-generated list of relevant query terms related to the user's initial input term according to an embodiment of the invention. Specifically, as the user enters a term, the GUI 761 displays a dropdown list of related terms to help the user select/input precise terms. For example, as the user enters the action term “bake” in the first text box 766, the GUI 761 displays a dropdown list 771 of action terms related to baking, such as, for example, cook, brown, souse, coddle, microwave, etc.

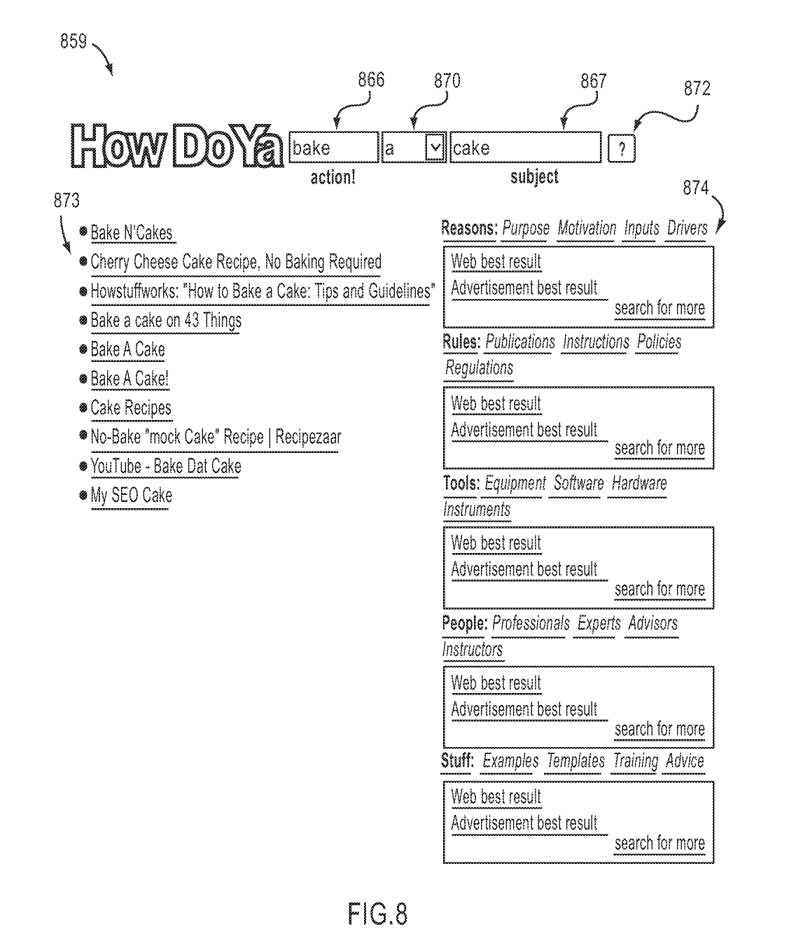

FIG. 8 illustrates an example of a GUI 859 including a returned result set 873 according to an embodiment of the invention. The GUI 859 includes a first text box 866, a second text box 867 and a third text box 870 as described above. The GUI 859 also includes an icon link 872 that the user can select to gain access to more information about the constrained fields. The returned result set 873 includes multiple links to various sources of information associated with the search terms. For example, the sources of information can include information about cake recipes, baking steps, etc. The GUI 859 also includes multiple categories 874, such as, for example, reasons, rules, tools, people, stuff, etc. For example, the tools category includes various links to tools associated with the search terms. In other words, if the user is searching how to “bake a cake,” one or more of the links in the tools category can be to tools associated with baking a cake, such as, for example, an oven, a baking pan, a mixing bowl, etc.

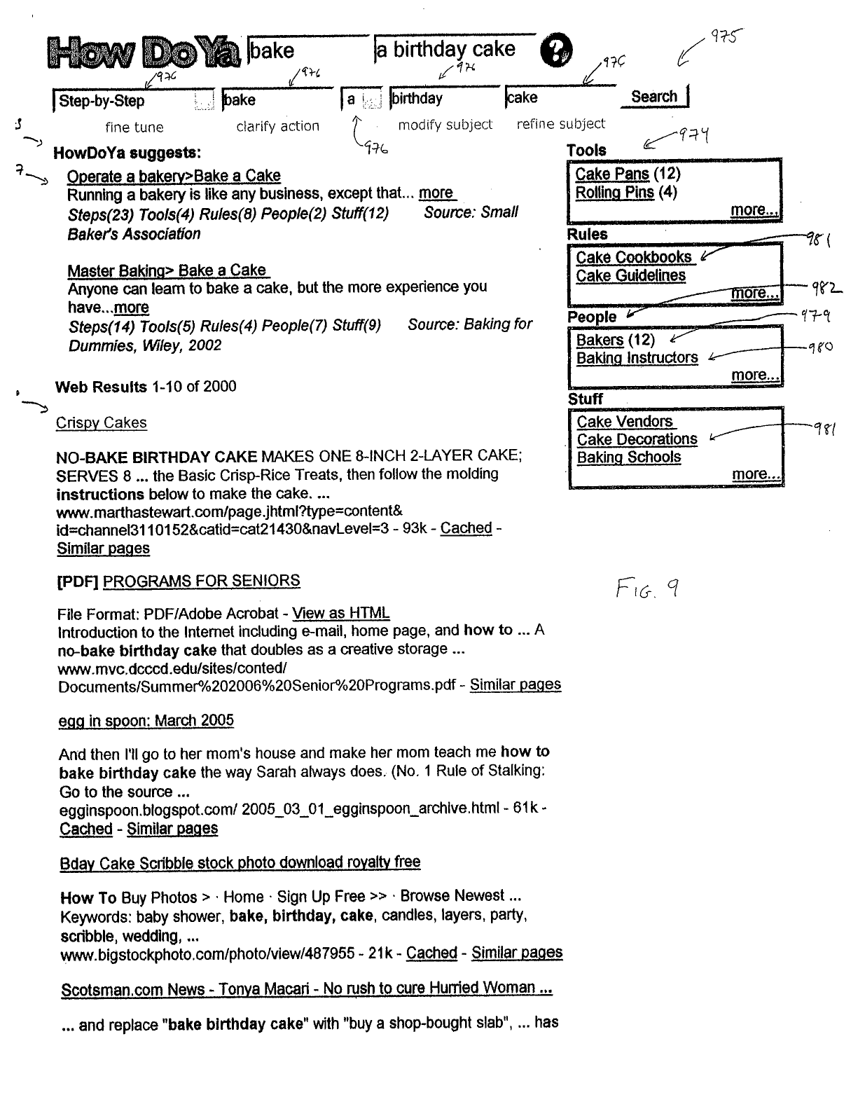

FIG. 9 illustrates another example of a GUI 975 including a returned result set 973 according to an alternative embodiment of the invention. The GUI 975 includes multiple refinement text boxes 976 configured to aid the user in clarifying and refining the initial search terms. Following the above example, the multiple refinement text boxes 976 can clarify that the user desires results relating to a step-by-step process for baking a birthday cake. The GUI 975 includes a system-suggested result portion 977 and a web result portion 978. The system-suggested result portion 977 includes various links to results that the system has identified as being potentially more relevant to the query than other results. The web result portion 978 includes various links to results the systems has identified to be relevant via the Internet. The system-suggested result portion 977 and/or the web result portion 978 can be ordered and reordered according to user specification. Although only two result portions 977 and 978 are illustrated in FIG. 9 and described in detail, it should be understood that the results can be from any of a variety of different sources and/or types, including for example, a knowledgebase, a database, a memory, etc. The GUI 975 can also include multiple categories 974. Each of the categories includes various links to information associated with the query. Additionally, one or more of the categories can include advertisements 981 for products or services associated with the search query. For example, the people category 982 can include a link 979 to a professional that can perform the process queried, such as, for example, a baker who can bake a birthday cake. The GUI 975 can also include a link 980 to an expert to whom the user can direct questions and gain advice and information about the query.

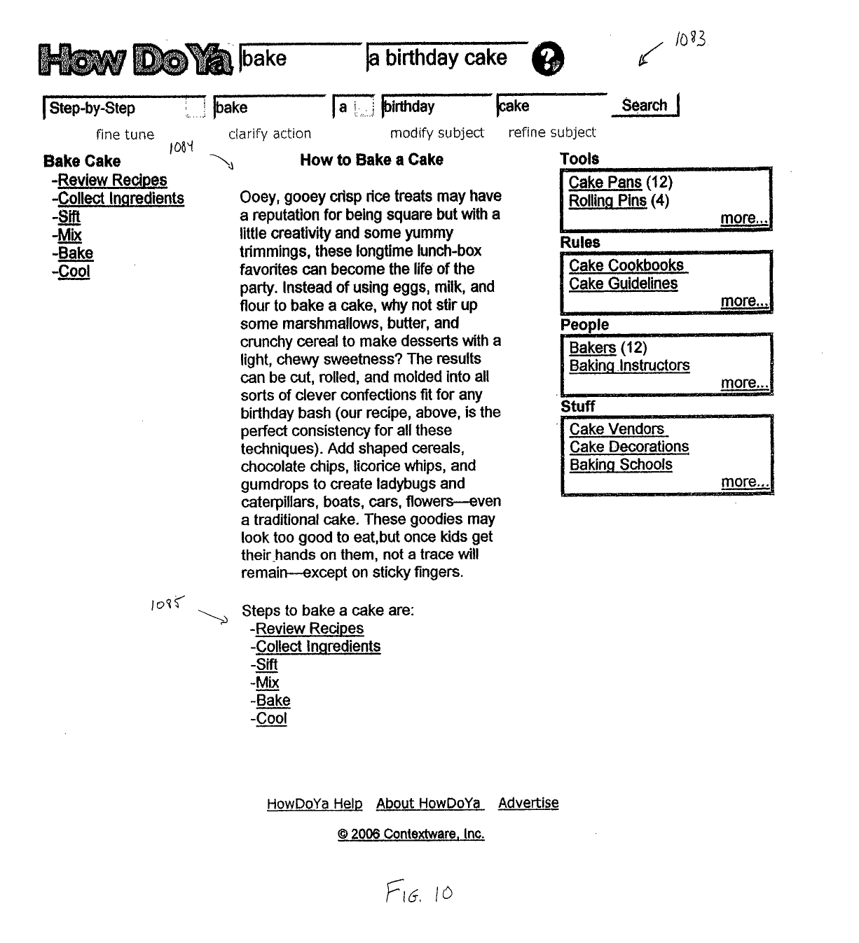

FIG. 10 illustrates another example of a GUI 1083 including a returned result according to an alternative embodiment of the invention. Once a user selects from the list of results, the GUI 1083 displays the specific result 1084 associated with the query. Following the above example, the specific result can include the step-by-step instruction on how to bake a birthday cake. In an alternative embodiment, the specific result 1084 can display information associated with a process or item similar to the query, such as, for example, how to bake crisp rice treats. The GUI 1083 can display various links 1085 to more specific information about the process queried.

While various embodiments of the invention have been described above, it should be understood that they have been presented by way of example only, and not limitation. Thus, the breadth and scope of the invention should not be limited by any of the above-described embodiments, but should be defined only in accordance with the following claims and their equivalents. While the invention has been particularly shown and described with reference to specific embodiments thereof, it will be understood that various changes in form and details may be made.

What is claimed is:

1. A method, comprising:
receiving data associated with a process query, the data including values associated with a predetermined constraint;
obtaining results for the process query from at least one data store;
outputting in a first form the obtained results for the process query;
outputting in a second form the obtained results.

2. The method of claim 1, wherein the receiving data includes receiving data via a web browser.

3. The method of claim 1, wherein the predetermined constraint includes limiting the data associated with a process query to include a subject and a verb.

4. The method of claim 1, further comprising refining the process query based on alternative process query terms before outputting in the first form the obtained results.

5. The method of claim 1, further comprising refining the process query based on alternative terms selected from a predetermined data set before outputting in the first form the obtained results.

6. The method of claim 1, wherein the at least one data store includes data stored on a computer network.

7. The method of claim 1, wherein the at least one data store is a process knowledgebase.

8. The method of claim 1, wherein the obtained results are categorized by data type.

9. The method of claim 1, wherein the obtained results are reordered by relevance based upon the quantity of occurrences of a particular process data type within the obtained results.

10. The method of claim 1, wherein the obtained results are limited to results containing the advice of experts.

11. The method of claim 1, further comprising displaying advertisements related to the process query.

12. A method, comprising:
creating a searchable process knowledgebase based on a business process;
integrating the business process into a process-based query algorithm;
adding obtained process query results to the process knowledgebase;
analyzing executed process queries so that the process-based query algorithm learns and improves precision of obtained process query results.

13. The method of claim 12 wherein creation of the business process takes place in a web browser.

14. The method of claim 12 wherein the business process is modifiable by use of an editing tool.

15. A processor-readable medium storing code storing code representing instructions to cause a processor to perform a process, the code comprising code to:
receive data associated with a process query, the data including values associated with a predetermined constraint;
obtain results for the process query from at least one data store;
output the obtained results for the process query;
output in a second form the obtained results.

16. The processor-readable medium of claim 15, wherein the receiving data includes receiving data via a web browser.

17. The processor-readable medium of claim 15, wherein the predetermined constraint includes limiting the data associated with a process query to include a subject and a verb.

18. The processor-readable medium of claim 15, the code further comprising code to refine the process query based on alternative process query terms before outputting in the first form the obtained results.

19. The processor-readable medium of claim 15, the code further comprising code to refine the process query based on alternative terms selected from a predetermined data set before outputting in the first form the obtained results.

20. The processor-readable medium of claim 15, wherein the at least one data store includes data stored on a computer network.

21. The processor-readable medium of claim 15, wherein the at least one data store is a process knowledgebase.

22. The processor-readable medium of claim 15, wherein the obtained results are categorized by data type.

23. The processor-readable medium of claim 15, wherein the obtained results are reordered by relevance based upon the quantity of occurrences of a particular process data type within the obtained results.

24. The processor-readable medium of claim 15, wherein the obtained results are limited to results containing the advice of experts.

25. The processor-readable medium of claim 15, the code further comprising displaying advertisements related to the process query.

26. A processor-readable medium storing code storing code representing instructions to cause a processor to perform a process, the code comprising code to:
create a searchable process knowledgebase based on a business process;
integrate the business process into a process-based query algorithm;
add obtained process query results to the process knowledgebase;
analyze executed process queries so that the process-based query algorithm learns and improves precision of obtained process query results.

27. The processor-readable medium of claim 26, wherein creation of the business process takes place in a web browser.

28. The processor-readable medium of claim 26, wherein the business process is modifiable by use of an editing tool.
